(19) United States
(12) Patent Application Publication
(10) Pub. No.: US 2026/0088642 A1
(43) Pub. Date: Mar. 26, 2026

(54) BATTERY PACK CHARGER

(71) Applicant: MILWAUKEE ELECTRIC TOOL CORPORATION, Brookfield, WI (US)

(72) Inventors: Vivek S. Nagal, Sussex, WI (US); Xuechao Wang, Pewaukee, WI (US); Paul C. Chao, Menomonee Falls, WI (US)

(21) Appl. No.: 19/337,323

(22) Filed: Sep. 23, 2025

Related U.S. Application Data
(60) Provisional application No. 63/698,274, filed on Sep. 24, 2024.

(51) Int. Cl. H02J 7/00; H02M 1/42; H02M 1/44; H02M 3/00; H02M 3/158; H02M 3/335

(52) U.S. Cl. CPC H02J 7/751; H02M 1/42; H02M 1/44; H02M 3/01; H02M 3/158; H02M 3/33571; H02J 2207/20

(57) ABSTRACT

A battery pack charger may include a housing. The battery pack charger may include a battery pack interface provided on the housing and configured to removably receive a battery pack. The battery pack charger may include a power input. The battery pack charger may include an LLC converter including a dual transformer electrically connected between the power input and the battery pack interface. The battery pack charger may include a power factor correction (PFC) boost converter electrically connected between the power input and the battery pack interface. The battery pack charger may include an input inrush current control circuit electrically connected between the PFC boost converter and the battery pack interface.

### CROSS-REFERENCE TO RELATED APPLICATIONS

This Application claims priority to U.S. Provisional Ser. No. 63/698,274 filed on Sep. 24, 2024, which is incorporated by reference herein in its entirety.

### FIELD

The present disclosure relates to battery pack chargers and particularly to battery pack chargers for charging multiple battery packs.

### BACKGROUND

Chargers may be used to charge rechargeable battery packs for various applications including power tool battery packs.

### SUMMARY

The present disclosure provides, in one aspect, a battery pack charger for charging multiple battery packs including a first-type battery pack and a second-type battery pack.

In some aspects, the disclosure herein relates to a battery pack charger including a housing and a battery pack interface provided on the housing and configured to removably receive a battery pack. The battery pack charger including a power input and an LLC converter including a dual transformer electrically connected between the power input and the battery pack interface.

In some aspects, the disclosure herein relates to a battery pack charger including a housing and a battery pack interface provided on the housing and configured to removably receive a battery pack. The battery pack charger including a power input and a power factor correction (PFC) boost converter electrically connected between the power input and the battery pack interface. The battery pack charger including an input inrush current control circuit electrically connected between the PFC boost converter and the battery pack interface.

In some aspects, the disclosure herein described herein relates to a battery pack charger including a housing and a battery pack interface provided on the housing and configured to removably receive a battery pack. The battery pack charger including a power input and a power factor correction (PFC) boost converter electrically connected between the power input and the battery pack interface and including interleaved PFC stages.

Other features and aspects of the disclosure will become apparent by consideration of the following detailed description and accompanying drawings.

### BRIEF DESCRIPTION OF THE DRAWINGS

FIG. 1 is a battery pack charger with multiple battery pack interfaces according to some aspects of the disclosure herein.

FIG. 2 is an example of a first-type battery pack receivable in one of the multiple battery pack interfaces of FIG. 1, according to an aspect of the disclosure herein.

FIG. 3 is an example of a second-type battery pack receivable in one of the multiple battery pack interfaces of FIG. 1, according to another aspect of the disclosure herein.

FIG. 4 illustrates a schematic of a control system for the battery pack charger of FIG. 1 according to some aspects of the disclosure herein.

FIG. 5A illustrates a schematic of the battery pack charger of FIG. 1 including a first portion of a charging circuit according to some aspects of the disclosure herein.

FIG. 5B illustrates a schematic of the battery pack charger of FIG. 1 including a second portion of the charging circuit according to some aspects of the disclosure herein.

FIG. 5C illustrates a schematic of the battery pack charger of FIG. 1 including a third portion of the charging circuit according to some aspects of the disclosure herein.

FIG. 6 illustrates a power factor correction converter for the charging circuit of FIG. 5A according to an aspect of the disclosure herein.

FIG. 7 illustrates an input inrush current control circuit for the charging circuit of FIG. 5A according to an aspect of the disclosure herein.

FIG. 8 illustrates an LLC converter for the charging circuit of FIGS. 5A and 5B according to an aspect of the disclosure herein.

FIG. 9 illustrates a charge control circuit for the charging circuit of FIG. 5 according to an aspect of the disclosure herein.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one. ” Rather these articles should be interpreted as meaning “at least one” or “one or more. ” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other aspects of the embodiments will become apparent by consideration of the detailed description and accompanying drawings.

### DETAILED DESCRIPTION

Some types of power tools utilize battery packs for power. Different battery packs are utilized for different power tools depending on an amount of power needed to use the power tool. With additional types of and multiple interfaces for battery packs, improvements in thermal management and efficient power distribution is desired to maintain comparable or improved time for battery charging. The circuitry for charging batteries disclosed herein enables lower AC losses and lower core losses which improves thermal management. Further the converters disclosed herein decrease heat generated in the system. In terms of manufacturing, the circuitry disclosed herein reduces the physical footprint for the battery pack charger while providing for ease in manufacturing by utilizing a relatively small common core and thin wires. Other advantages provided by the circuitry disclosed herein provide improvements in power consumption and relay reliability. Additionally electromagnetic interference as discussed herein is generally decreased. Combined, these benefits provide for a battery pack charger that maintains or decreases thermal dissipation whilst providing comparable or decreased time to fully charge the battery packs disclosed herein.

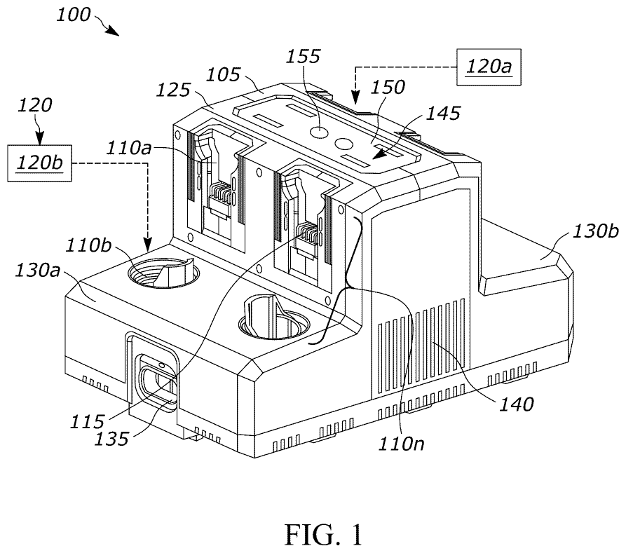

With reference to FIG. 1, an example battery pack charger 100 having a housing 105 and including multiple battery pack interfaces 110a, 110b is illustrated. Each of the multiple battery pack interfaces 110a, 110b includes corresponding charger terminals 115. The battery pack charger 100 may be configured to charge different types of battery packs 120. The housing 105 includes a middle wall 125 and two bases, a first base 130a and a second base 130b extending outwards from the middle wall 125 in opposite directions forming an upside-down “T” shape.

Two first-type battery pack interfaces 110a may be disposed on one side of the middle wall 125 facing the first base 130a and two first-type battery pack interfaces 110b may be disposed on another side of the middle wall 125 facing the second base 130b. Additionally, the first base 130a may include two second-type battery pack interfaces 110b. Likewise, the second base 130b may include two second-type battery pack interfaces (not shown). A single first-type battery pack interface 110a and a single second-type battery pack interface 110b together define a nested battery pack interface 110n. In other words, two nested battery pack interfaces 110n may be located on each side of the middle wall 125.

The first-type battery pack interfaces 110a are configured to removably (e.g., slidably) receive first-type battery packs 120a. The second-type battery pack interfaces 110b are configured to removably receive second-type battery packs 120b. In one example the first-type battery pack 120a is an 18V battery pack and the second-type battery pack 120b is a 12V battery pack. Only one of either the first-type battery pack 120a or the second-type battery pack 120b may be engaged in one of the nested battery pack interfaces 110n at a time. That is, when a first-type battery pack 120a is received in the first-type battery pack interface 110a of a nested battery pack interface 110n, the second-type battery pack interface 110b is blocked (e.g., partially or completely by the first-type battery pack 120a) from receiving the second-type battery pack 120b and vice versa.

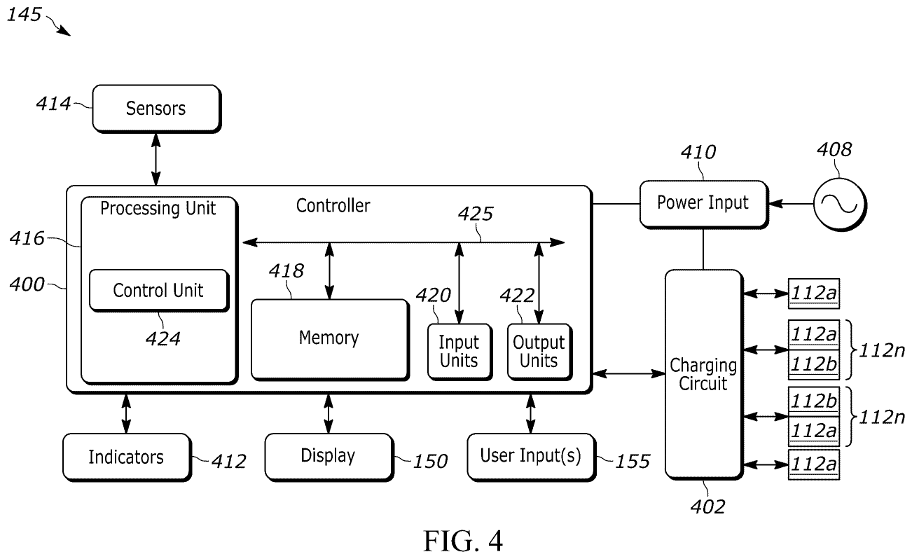

The battery pack charger 100 may further include one or more vents 140 for providing air circulation. The battery pack charger 100 may be configured for connection with a power source (FIG. 4) via a power input (FIG. 4). The battery pack charger 100 may have a total power output of about 792 Watts (792 W) and a maximum total charging current of about 36 Amperes (36A). The maximum current may range from at least 30 Amperes to at least 40 Amperes (30 A - 40 A).

The different types of battery packs 120 may include a high output battery pack (e.g., having a current capacity of 12amp-hours (Ah) or more). The different types of battery packs 120 may be, for example, a Lithium-ion chemistry-based power tool battery pack having a nominal voltage of about 18 Volts. The different types of battery packs may have a nominal voltage of about 36 Volts, 48 Volts, 72 Volts, or the like. Further, the different types of battery packs 120 may include a 12-volt power tool battery pack having three (3) Lithium-ion battery cells or may include fewer or more battery cells. Additionally, or alternatively, the battery cells may have chemistries other than lithium-ion such as, for example, nickel cadmium, nickel metal-hydride, or the like.

Each battery pack 120a, 120b may be connectable to and operable for powering various motorized power tools (e.g., a cut-off saw, a miter saw, a table saw, a core drill, an auger, a breaker, a demolition hammer, a compactor, a vibrator, a compressor, a drain cleaner, a welder, a cable tugger, a pump, etc.), outdoor tools (e.g., a chain saw, a string trimmer, a hedge trimmer, a blower, a lawn mower, etc.), other motorized devices (e.g., vehicles, utility carts, a material handling cart, etc.), and non-motorized electrical devices (e.g., a power supply, a light, an AC/DC adapter, a generator, etc.).

The battery pack charger 100 may further include a control system 145 for interacting with and controlling the battery pack charger 100. The control system 145 may include, among other things, a display 150 with user inputs 155 for a user to interact with the battery pack charger 100.

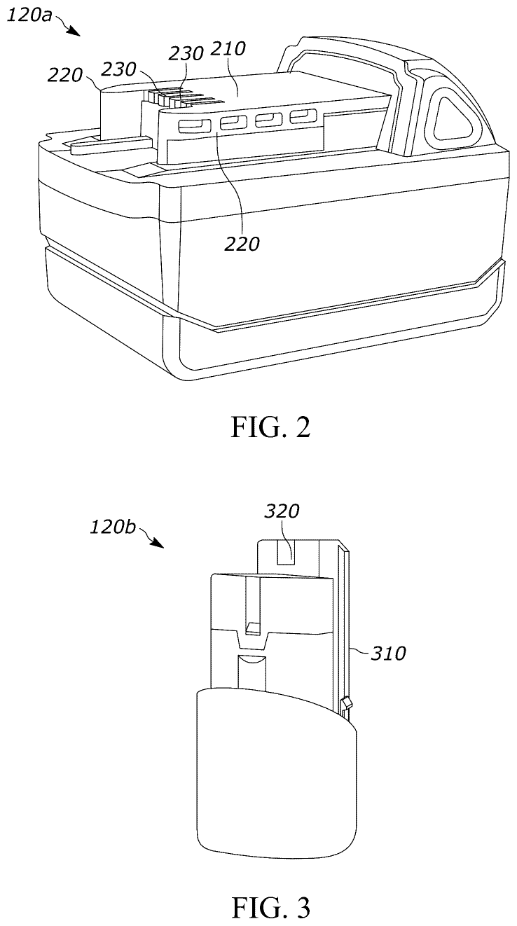

Turning to FIG. 2, an example of the first-type battery pack 120a is illustrated. The first-type battery pack 120a may include a connection portion 210 with two parallel, spaced apart rails 220 such that first-type battery pack 120a is a slide-on-style battery pack for slidable engagement with the first-type battery pack interface 110a. The connection portion 210 also includes battery terminals 230 to electrically connect the first-type battery pack 110a to the charger terminals 115 of the battery pack charger 100 or to another device, such as a power tool.

Turning to FIG. 3, an example of the second-type battery pack 120b is illustrated. The second-type battery pack 120b may include a connection portion 310 in the form of a tower-style for at least partial insertion into the second-type battery pack interface 110b. The connection portion 310 also includes battery terminals 320 to electrically connect the second-type battery pack 120b to charger terminals (not shown FIG. 1) of the battery pack charger 100 or to another device, such as a power tool.

The first-type battery pack 120a and the second type battery pack 120b are described as being slid and/or inserted into the battery pack charger 100. While slidable and insertable interfaces are illustrated, any type of interface capable of electrically connecting the different types of battery packs 116 to the battery pack charger 100 is contemplated including snapping, rotating, or the like.

FIG. 4 illustrates a schematic of the control system 145. The control system 145 includes a controller 400 that may be electrically and/or communicatively connected to a variety of components of the battery pack charger 100. The controller 400 may include one or more micro processing units or one or more microcontroller units (MCU) or any combination of micro processing units and MCUs. The connection may be wireless or wired. In some examples the controller 400 receives wireless inputs from an application running on an external device (e. g, a smartphone, a tablet, a laptop computer, or the like). The controller 400 may be connected to the display 150, one or more of the user inputs 155, a charging circuit 402, a power input 410, one or more indicators 412, and one or more sensors 414. The controller 400 may be configured to provide, using the charging circuit 402, a maximum current of about 36A, and a maximum power of 792 W, from the power source 408 via the power input 410. The maximum current may range from at least 30 A to at least 40 A. The power source 408 may be an AC input, for example, a utility power or power from a power generator.

The controller 400 may include combinations of hardware and software that are operable to, among other things, control the operation of the battery pack charger 100, monitor the operation of the battery pack charger 100, activate the one or more indicators 412, sense current being drawn by the battery pack charger 100, and control an amount of current conducted by the charger terminals 115.

The controller 400 may include a plurality of electrical and electronic components that provide power, operational control, and protection to the components within the controller 400 and/or the battery pack charger 100. For example, the controller 400 includes, among other things, a processing unit 416 (e.g., a microprocessor, a microcontroller, or another suitable programmable device referred to as an electronic processor), a memory 418, input units 420, and output units 422. The processing unit 416 includes, among other things, a control unit 424 and is implemented using a known computer architecture (e.g., a modified Harvard architecture, a von Neumann architecture, etc.). The processing unit 416, the memory 418, the input units 420, and the output units 422, as well as the various components or circuits connected to the controller 400 are connected by one or more control and/or data buses (e.g., common bus 425). The control and/or data buses are shown generally in FIG. 4 for illustrative purposes. The use of one or more control and/or data buses for the interconnection between and communication among the various modules, circuits, and components would be known to a person skilled in the art.

The memory 418 may be a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 416 is connected to the memory 418 and executes software instructions that are capable of being stored in a RAM of the memory 418 (e.g., during execution), a ROM of the memory 418 (e.g., on a generally permanent basis), or another non-transitory computer readable medium such as another memory or a disc. Software included in the implementation of the battery pack charger 100 may be stored in the memory 418 of the controller 400. The software may include, for example, firmware, one or more applications, program data, filters, rules, one or more program modules, and other executable instructions. The controller 400 is configured to retrieve from the memory 418 and execute, among other things, instructions related to the control processes and methods described herein. In other constructions, the controller 400 includes additional, fewer, or different components.

The one or more input units 420 may be operably coupled to the controller 400 to, for example, turn the battery pack charger 100 on or off. In some embodiments, the one or more input units 420 may include a combination of digital and analog input or output devices required to achieve a desired level of operation for the battery charging station, such as one or more knobs, one or more dials, one or more switches, one or more buttons, etc. In some embodiments, the one or more input units 420 may receive signals wirelessly from a device external to the battery pack charger 100 (e.g., a user's mobile phone).

The power input 410 includes an interface to be connected to the power source 408. In one example, the power input 410 includes a power cord interface to receive a power cord that may be connected to a wall outlet or an external power generator. In some examples, the power input 410 may include a connection to a vehicle power system, solar panels, or the like.

The indicators 412 include, for example, one or more light-emitting diodes (“LEDs”). The indicators 412 may be configured to display conditions of, or information associated with, the battery pack charger 100. For example, the indicators 412 are configured to indicate measured electrical characteristics of the battery pack charger 100, the status of the battery pack charger 100, the status of an amount of remaining charge for the battery packs 116a, 116b etc. The one or more sensors 414 include, for example, a temperature sensor, a current sensor, a voltage sensor, and/or the like. The one or more sensors 414 measure various parameters of the battery pack charger 100 and provide a signal corresponding to the measured parameter to the controller 400 for processing.

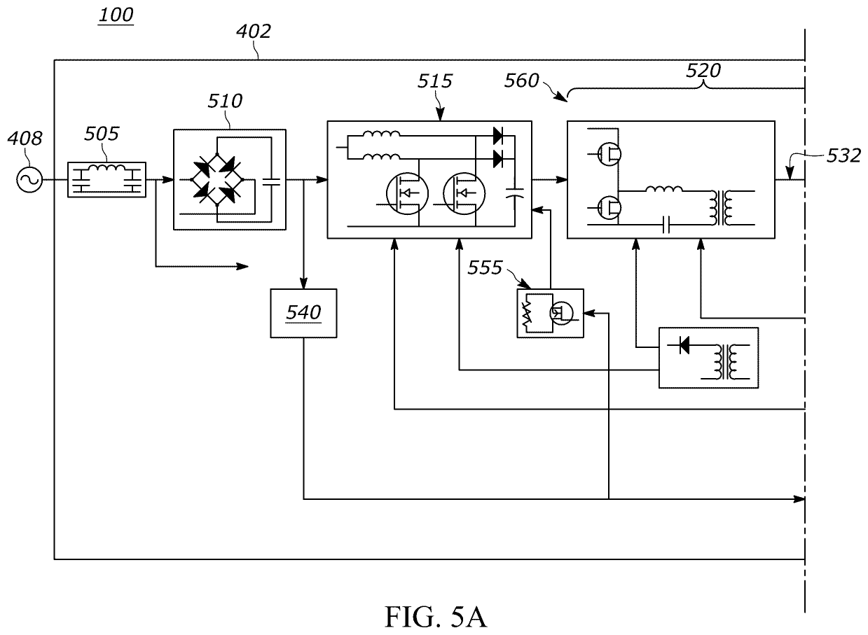

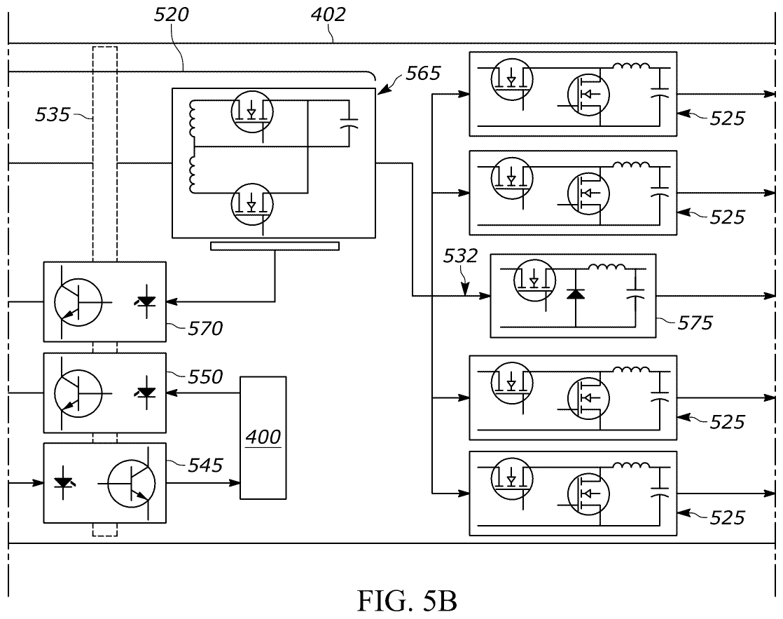

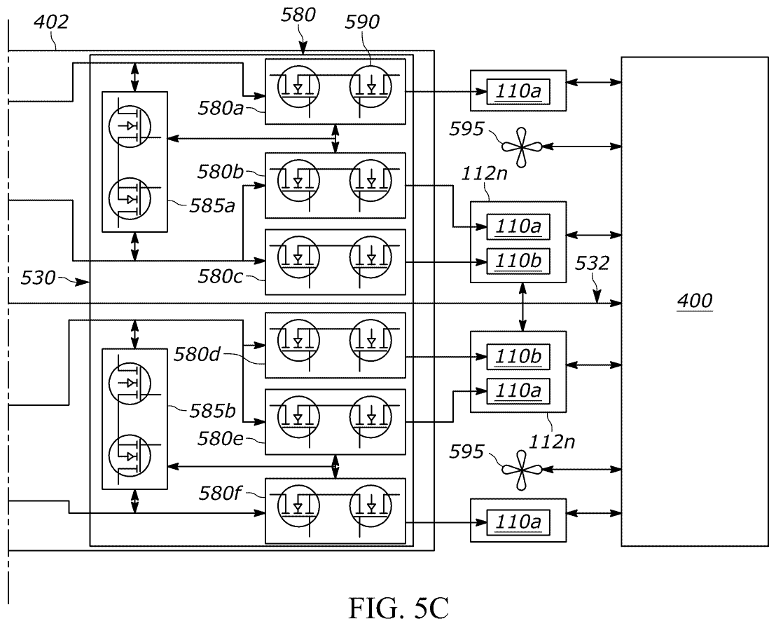

FIGS. 5A-5C illustrates a schematic of the battery pack charger 100 including the charging circuit 402 in more detail. The charging circuit 402 is disposed within the housing 105 and electrically connected to each of the multiple battery pack interfaces 110a, 110b. The charging circuit 402 is electrically connected to a power source 408 via, by way of example, the power input 410. A power path 532 extends from the power source 408 to the charger terminals 115. The charging circuit 402 includes an electromagnetic interference (EMI) filter 505, an input rectifier 510, a power factor correction (PFC) boost converter 515, an LLC resonant converter 520, a plurality of synchronous DC-DC buck converters 525, and a switch circuit assembly 530, each defining at least a portion of the power path 532. A galvanic isolation barrier 535 separates the high-voltage components from the low-voltage components. In one example, the galvanic isolation barrier 535 is provided by the LLC resonant converter 520 on the power path 532.

The EMI filter 505 is connected to the power source 408 to filter out electromagnetic interference and provide the filtered power to the input rectifier 510. The EMI filter 505 includes an inductor and capacitor arrangement to filter out electromagnetic interference. The input rectifier 510 receives filtered power from the EMI filter 505 and rectifies the AC power, where AC power from the power source 408 is converted to DC power. An AC bounded-input bounded-output (BIBO) detection circuit 540 is coupled to the output of the input rectifier 510 to detect presence of the power source 408. The AC BIBO detection circuit 540 provides a detection signal to the controller over a first photocoupler 545 across the galvanic isolation barrier 535 to indicate the presence of AC power from the power source 408.

The LLC resonant converter 520 is electrically connected on a primary side 560 to the PFC boost converter 515. The PFC boost converter 515 converts DC power from the input rectifier 510 by boosting the voltage to, for example 395 V, 400 V or the like, in comparison to a voltage provided by the power source 408, (e.g., 110/120 Volts and 240 Volts). An input inrush current control circuit 555 is coupled to the PFC boost converter 515. The input inrush current control circuit 555 is configured to limit an amount of in-rush current flowing to the PFC boost converter 515 at startup when connected to the power source 408. For a low power AC input, the input inrush current control circuit 555 may be electrically connected to the power source 408, or on an input side of the PFC boost converter 515 (not shown). However, in the example illustrated, the input inrush current control circuit 555 is provided on an output side of the PFC boost converter 515 to prevent an inrush of current and therefore potential damage to the charging circuit 402.

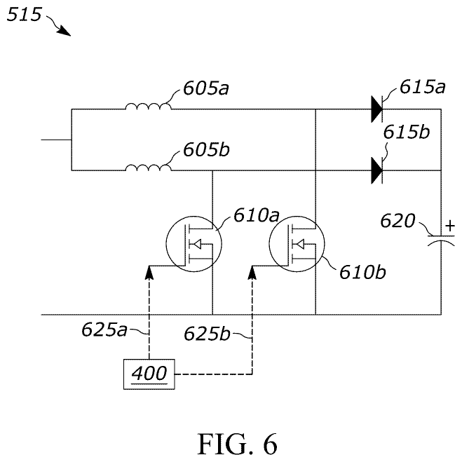

FIG. 6 illustrates one example of the PFC boost converter 515. In the example illustrated, the PFC boost converter 515 is an interleaved PFC boost converter with interleaved PFC stages. A first PFC stage (parts including an “a”) may include a first inductor 605a and a first diode 615a. A second PFC stage (parts including a “b”) may include a second inductor 605b and a second diode 615b. The first PFC stage may be electrically connected to a first field effect transistor (FET) 610a. The second PFC stage may be electrically connected to a second FET 610b.

The two inductors 605a, 605b are connected in parallel to each other between the input and the output of the PFC boost converter 515. The first inductor 605a is connected in series with the first diode 615a and the second inductor 605b is connected in series with the second diode 615b between the input and the output of the PFC boost converter 515. The first FET 610a selectively connects the first inductor 605a to ground and the second FET 610b selectively connects the second inductor 605b to ground. The controller 400 provides a first gate pulse 625a to the first FET 610a and a second gate pulse 625b to the second FET 610b to control the PFC boost converter 515. The first and second gate pulses 625a, 625b are 180° phase shifted such that when the first FET 610a is switched on, the second FET 610b is off, and vice versa. When compared to a conventional PFC converter, the interleaved PFC boost converter 515 lowers the electromagnetic interference (EMI). A second photocoupler 550 is used to provide control signals from the controller 400 to the PFC boost converter 515 across the galvanic isolation barrier 535.

Advantages associated with incorporating the interleaved PFC boost converter 515 may include better thermal management, lower EMI due to ripple current cancellation, lower current stress on the output capacitor 620, and smaller magnetic size (30% less compared to a single PFC).

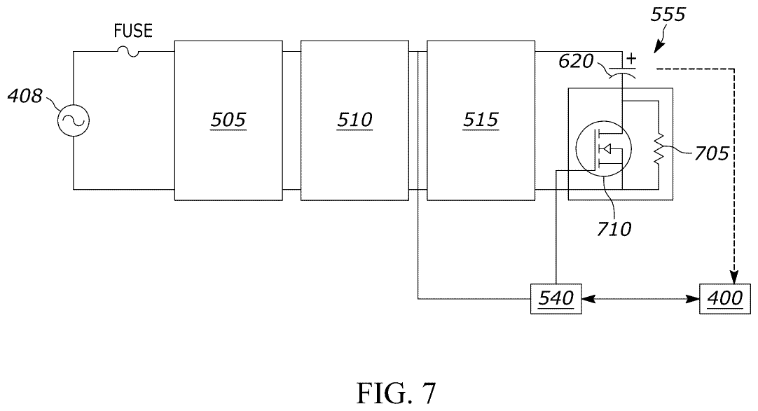

FIG. 7 illustrates the input inrush current control circuit 555 according to one aspect of the disclosure herein. The input inrush current control circuit 555 includes a negative temperature coefficient (NTC) thermistor 705 and a bypass FET 710. The controller 400 detects when the output capacitor 620 is charged to a peak voltage and in response controls the bypass FET 710 to turn on. In some examples, the bypass FET 710 may be controlled in conjunction with the AC BIBO detection circuit such that the bypass FET710 is controlled only when the AC power is detected.

Incorporating the input inrush current control circuit 555 with a FET rather than a relay and in series with the PFC boost converter 515 rather than in series between the power source 408 and the EMI filter 505 may provide lower power consumption. Further, the bypass FET 710 may not need to be rated for high current provided at the power source 408. Additionally, FETs are more reliable than relays and occupy less physical space than relays.

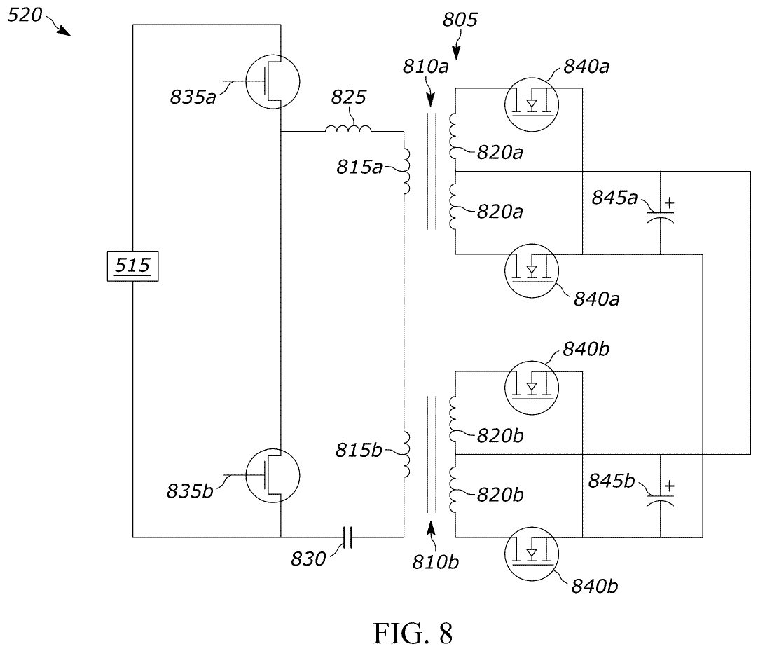

FIG. 8 illustrates an example half bridge LLC resonant DC-DC converter 520 according to one aspect of the disclosure herein. The LLC resonant converter 520 is, for example, a dual transformer 805 having two separate equivalent transformers 810a, 810b. Each transformer 810a, 810b includes a corresponding primary winding 815a, 815b which are connected in series to each other and are equivalent in both function and structure. Further, corresponding secondary windings 820a, 820b are connected in parallel to each other and are equivalent in both function and structure. The primary windings 815a, 815b are further connected in series to an inductor 825 and a capacitor 830.

A first power switch 835a is connected between the input and the primary windings 815a, 815b. A second power switch 835b is connected in parallel to the primary windings 815a and 815b. The controller 400 controls the power switches 835a, 835b when power is supplied from the PFC boost converter 515 to induce a current in the secondary windings 820a, 820b. Secondary switches, e.g. additional FETs 840a, 840b, act as synchronous rectifiers to regulate the current on the secondary side 565 of the LLC resonant converter 520. The charging capacitors 845a, 845b enable a 36V source for the rest of the charging circuit 402. When included, the dual transformer design may provide improved thermal management by lowering AC and core losses which improves efficiency. A lower turn ratio reduces interwinding capacitance which improves EMI. Further, the dual transformer design reduces an overall footprint of the circuit and improves manufacturing by requiring a small core and thin wires.

Referring now to FIG. 5B, the LLC resonant converter 520 is electrically connected on a secondary side 565 to the synchronous DC-DC buck converters 525. The LLC resonant converter 520 receives power at, for example, about 395 V and about 890 W and converts the voltage to 36V at a power of about 860 W on the secondary side 565. A third photocoupler 570 is used to provide feedback signals between the primary side 560 and the secondary side 565 of the LLC converter 520.

A housekeeping supply 575 may be connected between the LLC converter 520 and the controller 400 for providing operating power to the controller 400 and other electrical components.

The synchronous DC-DC buck converters 525 includes, for example, four synchronous buck converters corresponding to the battery pack interfaces 110. Each synchronous DC-DC buck converter 525 may correspond with at least one of the battery pack interfaces 110. By way of example two synchronous DC-DC buck converters 525 are dedicated to the two first-type battery pack interfaces 110a and two synchronous DC-DC buck converters 525 are dedicated to the two nested battery pack interfaces 110n. The controller 400 controls the synchronous DC-DC buck converters 525 to convert the power to the appropriate voltage and current to be provided to the battery packs 120. The housekeeping supply 575 may also include a synchronous DC-DC buck converter.

Turning to FIG. 5C, in one example, the switch circuit assembly 530 is electrically connected between the synchronous DC-DC buck converters 525 and the battery pack interfaces 110. In one example, the switch circuit assembly 530 includes one or more FETs (e.g., charge FETs) to enable/disable charging current and/or adjust amount of charging current between the power source 408 and the multiple battery pack interfaces 110. The controller 400 may provide pulse-width modulated (PWM) signals to the switch circuit assembly 530 to control the amount of current flowing between the power input and the multiple battery pack interfaces 110.

The switch circuit assembly 530 includes a plurality of switch circuits 580 each having at least one switch, by way of example, a FET 590. In one example, the FETs 590 are back-to-back N-Channel FETs. A bipolar junction transistor, or the like is also contemplated. A gate driver may be connected between the controller 400 and the switch circuit 580. Each battery pack interface 110a, 110b may have a dedicated switch circuit 580. For example, a first charge circuit 580a, a second charge circuit 580b, a third charge circuit 580c, a fourth charge circuit 580d, a fifth charge circuit 580e, and a sixth charge circuit 580f correspond to each of the six battery pack interfaces 110. Further, two intermediate switch circuits 585a, 585b, may be used to toggle between the first-type battery pack interfaces 110a and the nested battery pack interfaces 110b.

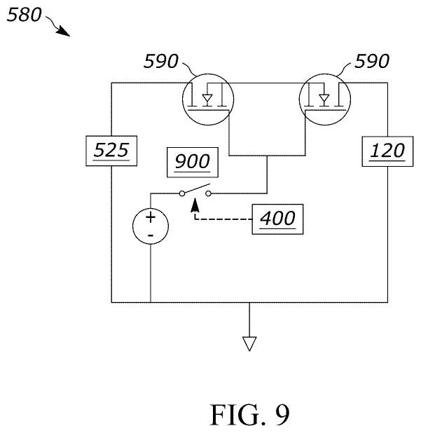

Referring to FIG. 9, a portion of the switch circuit 580 according to one aspect of the disclosure herein is illustrated. The switch circuit 580 includes the FETs 590. In one aspect the FETs 590 are N-Channel FETs connected in series between the synchronous DC-DC buck converters 525 and the battery pack interfaces 110. The two FETs 590 allow for additional safety to protect the battery packs 120 when one FET 590 fails. A gate control switch 900 is activated by the controller 400 when a battery pack 120 is present in the corresponding battery pack interface 110a, 110b (see FIG. 5C). When a battery pack is not present, the switch is opened and there is no flow in the switch circuit 580. The gate control switch 900 may receive power from an auxiliary power supply circuit, for example, a housekeeping power supply. The controller 400 activates the FETs 590 when a battery pack 120 is detected in the battery pack interface 110. A magnetic or other type of sensor may be provided in the battery pack interface 110a, 110b to signal to the controller 400 that a battery pack 120 is received in the corresponding battery pack interface 110. In one example, the controller 400 uses the switch circuit 580 to adjust an amount of the maximum charging current 36A that is supplied to the first-type battery pack interfaces 110a and to the second-type battery pack interfaces 110b. In another example, the controller 400 controls the synchronous DC-DC buck converters 525 to adjust the amount of the maximum charging current 36A that is supplied to the first-type battery pack interfaces 110a and to the second-type battery pack interfaces 110b. The maximum charging current 36A is distributed among the multiple interfaces, including the first-type battery pack interfaces 110a and the second-type battery pack interfaces 110b. The battery pack charger 100 may be able to distribute the maximum charging current 36A in different ways depending on different combinations of battery types.

The first-type battery pack interface 112a is configured to provide a charging power at a maximum voltage of 21 V and a maximum current of 36 A (that is, maximum power of 756 Watts) to the first-type battery pack. The second-type battery pack interface 112b is configured to provide a charging power at a maximum voltage of 12.6 V and a maximum current of 20 A (that is, maximum power of 252 Watts). A maximum power of 700 W to 800 W (for example, at 775 Watts or 792 Watts) at a maximum current of 36 A may be distributed between a maximum of four battery packs connected to the battery pack charger 100 in the example configuration illustrated. In other example configuration a different number of maximum battery packs may be charged using a different maximum power at a different maximum current.

Referring again to FIG. 5C, the battery pack charger 100 may further include at least one fan 595. The at least one fan 595, together with the one or more vents 140 and one or more temperature sensors defines a cooling circuit for controlling the temperature of the battery pack charger 100. The at least one fan 595 may be configured to cool the charging circuit 402 and the battery packs 120 when engaged with one of the first-type and the second-type battery pack interfaces 110. In one example, the battery pack charger 100 includes two or more fans 595.

In another example, a temperature sensor can be used to measure an internal temperature of the battery pack charger 100. When the temperature is too high or reaches one or more threshold temperature values, the controller 400 operates the one or more fans 595 to circulate air to reduce the temperature of the battery pack charger 100. In some embodiments, a switch (not shown) is provided between the power input 410 and the charging circuit 402 for shutting off power during a high temperature event.

Although detailed description is provided with reference to certain preferred embodiments, variations and modifications exist within the scope and spirit of one or more independent aspects described herein.

What is claimed is:

1. A battery pack charger comprising:
a housing;
a battery pack interface provided on the housing and configured to removably receive a battery pack;
a power input; and
an LLC converter including a dual transformer electrically connected between the power input and the battery pack interface.

2. The battery pack charger of claim 1, wherein the LLC converter is an LLC resonant converter and the dual transformer includes a first transformer and a second transformer,
wherein the first transformer is equivalent to the second transformer,
wherein a primary winding of the first transformer is connected in series with a primary winding of the second transformer, and
wherein a secondary winding of the first transformer is connected in parallel with a secondary winding of the second transformer.

3. The battery pack charger of claim 1, further comprising:
a power factor correction (PFC) boost converter electrically connected between the power input and the LLC converter and configured to boost input power from the power input,
an input inrush current control circuit electrically connected between the PFC boost converter and the LLC converter and configured to selectively limit current flow between the PFC boost converter and the LLC converter, and
a switch circuit assembly electrically connected between the LLC converter and the battery pack interface,
a controller electrically connected to the switch circuit assembly and configured to control, using the switch circuit assembly, an amount of charging current being supplied to the battery pack interface.

4. The battery pack charger of claim 3, further comprising a synchronous buck converter electrically connected between the LLC converter and the switch circuit assembly.

5. The battery pack charger of claim 3, further comprising:
an electromagnetic interference (EMI) filter electrically connected between the power input and the PFC boost converter; and
an input rectifier electrically connected between the EMI filter and the PFC boost converter.

6. The battery pack charger of claim 1, wherein the battery pack interface is multiple battery pack interfaces including a first battery pack interface configured to receive a first-type battery pack and a second battery pack interface configured to receive a second-type battery pack different from the first-type battery pack.

7. The battery pack charger of claim 1, wherein the battery pack interface is galvanically isolation from the power input.

8. A battery pack charger comprising:
a housing;
a battery pack interface provided on the housing and configured to removably receive a battery pack;
a power input;
a power factor correction (PFC) boost converter electrically connected between the power input and the battery pack interface;
an input inrush current control circuit electrically connected between the PFC boost converter and the battery pack interface.

9. The battery pack charger of claim 8, wherein the input inrush current control circuit includes a negative temperature coefficient (NTC) thermistor connected in parallel with a bypass field effect transistor (FET).

10. The battery pack charger of claim 9, further comprising a controller configured to activate the bypass FET when an output capacitor of the PFC boost converter reaches a peak voltage.

11. The battery pack charger of claim 10, further comprising:
an input rectifier electrically connected between the power input and the PFC boost converter and configured to rectify an AC input power to DC power provided to the PFC boost converter; and
an AC bounded-input bounded-output (BIBO) detection circuit electrically connected to the input rectifier and configured to detect a presence of a power source connected to the power input.

12. The battery pack charger of claim 11, wherein the controller is electrically connected to the AC BIBO detection circuit and further configured to:
control the bypass FET based on an output of the AC BIBO detection circuit.

13. The battery pack charger of claim 10, further comprising:
an LLC converter electrically connected between the PFC boost converter and the battery pack interface, and
a switch circuit assembly electrically connected between the LLC converter and the battery pack interface, wherein the controller is electrically connected to the switch circuit assembly and configured to control, using the switch circuit assembly, an amount of charging current being supplied to the battery pack interface.

14. The battery pack charger of claim 8, further comprises:
an electromagnetic interference (EMI) filter electrically connected between the power input and the PFC boost converter; and
an input rectifier electrically connected between the EMI filter and the PFC boost converter.

15. A battery pack charger comprising:
a housing;
a battery pack interface provided on the housing and configured to removably receive a battery pack;
a power input;
a power factor correction (PFC) boost converter electrically connected between the power input and the battery pack interface and including interleaved PFC stages.

16. The battery pack charger of claim 15, wherein the interleaved PFC stages include a first PFC stage and a second PFC stage connected in parallel between an input and an output of the PFC boost converter, wherein the first PFC stage includes a first inductor connected in series with a first diode and the second PFC stage includes a second inductor connected in series with a second diode.

17. The battery pack charger of claim 16, further comprising a first FET and a second FET, wherein the first FET selectively connects the first inductor to a ground and the second FET selectively connects the second inductor to the ground.

18. The battery pack charger of claim 15, further comprising:
an LLC converter electrically connected between the interleaved PFC boost converter and the battery pack interface;
an input inrush current control circuit electrically connected between the PFC boost converter and the LLC converter;
a switch circuit assembly electrically connected between the LLC converter and the battery pack interface; and
a controller electrically connected to the switch circuit assembly and configured to control, using the switch circuit assembly, an amount of the charging current being supplied to the battery pack interface.

19. The battery pack charger of claim 18, wherein the switch circuit assembly a first N-Channel FET and a second N-Channel FET connected in series.

20. The battery pack charger of claim 15, further comprises:
an electromagnetic interference (EMI) filter electrically connected between the power input and the PFC boost converter; and
an input rectifier electrically connected between the EMI filter and the PFC boost converter.
